(19) United States
(12) Patent Application Publication
(10) Pub. No.: US 2014/0251780 A1
(43) Pub. Date: Sep. 11, 2014

(54) Switching Device

(71) Applicant: OMRON CORPORATION, Kyoto-shi (JP)

(72) Inventors: Yoshihisa ISHIKAWA, Moriyama-shi (JP); Takeshi MIYASAKA, Higashiomi (JP); Toshinori YAMASUE, Koka-shi (JP)

(73) Assignee: OMRON CORPORATION, Kyoto-shi (JP)

(21) Appl. No.: 14/142,878

(22) Filed: Dec. 29, 2013

(30) Foreign Application Priority Data
Mar. 8, 2013 (JP) 2013-047292

(51) Int. Cl. H01H 23/14

(52) U.S. Cl. CPC H01H 23/148
USPC 200/561

(57) ABSTRACT

A switching device including a movable member configured to swing around a fulcrum and having a movable contact, a sliding member of which a part slides on a surface of the movable member, an elastic member for supporting the sliding member so as to be slidable while the part remains abutted on the surface, and a fixed contact contacted with the movable contact, where the movable member swings by a sliding of the sliding member, thereby switching a contact and a noncontact of the movable contact and the fixed contact so as to switch a conduction and a break of an electricity, and where the sliding member is configured to rotate so that a deformation of the elastic member is maximum in a position of the part on the surface, the position being deviated to a side of the contact position compared to a straight line which connects the shaft and the fulcrum.

### CROSS REFERENCE TO RELATED APPLICATION

This application is related to and claims priority to Japanese Patent Application Number 2013-047292 filed on 8 Mar. 2013, where the contents of said application are herein incorporated by reference in their entirety.

### BACKGROUND OF THE INVENTION

1. Technical Field

The present invention relates to a switching device which switches conduction and break of electricity by making a movable contact contacted with and separated from a fixed contact.

2. Related Art

A construction of a rocker switch used in power conditioners and connections boxes in a solar power generation system is well known. For example, in Japanese Unexamined Patent Publication No. 2012-198993 (Published on Oct. 18, 2012), a seesaw switch is disclosed in which an operation speed and an opening and closing speed of a contact thereof are separated. Further, in Japanese Unexamined Patent Publication No. 2012-156044 (Published on Aug. 16, 2012), a circuit breaker is disclosed which changes a current path going through a fixed contactor and a movable contactor into a loop state, thereby improving current limiting breaking performance of the circuit breaker. Furthermore, in Japanese Unexamined Patent Publication No. 2007-317586 (Published on Dec. 6, 2007), a circuit breaker is disclosed which protects an electric path from an overcurrent and which is improved in breaking performance. In Japanese Unexamined Patent Publication No. 2006-086066 (Published on Mar. 30, 2006), a breaker is disclosed in which a movable contact is closed with respect to a fixed contact at a stable speed by releasing energy of a closing spring. In Japanese Unexamined Patent Publication No. 2000-195367 (Published on Jul. 14, 2000), a structure of a fixed contactor in a breaker arc extinguishing portion used for breaking a high voltage current is disclosed. In Japanese Unexamined Patent Publication No. H11-297180 (Published on Oct. 29, 1999), a circuit breaker is disclosed which is configured to enhance a contact opening speed of a movable contactor upon large current break. In Japanese Unexamined Patent Publication No. H11-162285 (Published on Jun. 18, 1999), a switch mechanism is disclosed which forcibly establishes a non-contacted state when a contact of a switch is in a connected state due to welding by melting or the like.

Based on FIG. 11, a structure of a conventional switch represented by the seesaw switch described in Japanese Unexamined Patent Publication No. 2012-198993 will be described. FIG. 11 is a schematic view illustrating the main portion structure inside of the conventional switch. As illustrated in FIG. 11, the conventional switch includes a sliding member 51, a movable member 52, an operation button 53, a casing projection 55, a fixed contact 57, and a movable contact 58. When the sliding member 51 rotates about a shaft S whereby a tip end of the sliding member 51 slides on a sliding contact portion E of the movable member 52 (the tip end of the sliding member 51 moves while making contact with the sliding contact portion E), the movable member 52 swings around the casing projection 55 as a fulcrum R (namely, swings around the fulcrum like a seesaw), then the fixed contact 57 and the movable contact 58 are contacted with each other and separated from each other thereby switching between conduction and break of electricity (i.e., a state of no conduction).

Based on FIGS. 12A and 12B, problems of the above-mentioned conventional switch will be described. FIGS. 12A and 12B are schematic views illustrating how the above-mentioned conventional switch operates in time series; FIG. 12A illustrates how the fixed contact 57 and the movable contact 58 are contacted with each other and separated from each other in conjunction with the sliding of the sliding member 51, FIG. 12B enlarges a part of the sliding portion Eon which the tip end of the sliding member 51 slides and also indicates the direction of force applied by the sliding member 51 with an allow. In FIGS. 12A and 12B, the schematic views are called “state 1” to “state 7” in order from left to right in the schematic view.

As illustrated in FIGS. 12A and 12B, the above-mentioned switch goes through intermediate states (states 2 to 6) in which the fixed contact 57 and the movable contact 58 are close to each other. In the above-mentioned intermediate state, an arc occurs (i.e., an electricity discharge phenomenon in which a current flows in a gap between a surface of the fixed contact 57 and a surface of the movable contact 58. The occurrence of the arc deteriorates the material of surface, thereby causing a first problem in that the lifetime of the switch is shortened. When the switch is not shifted up to the final states (state 1 and state 7) and remains in the above-mentioned intermediate state by the switch operation being stopped halfway, the arc keeps occurring for a long time, thereby making the above-mentioned problem more serious.

Additionally, when the switch returns to the state 1 again without being shifted into the state 7 after the switch is shifted into the above-mentioned intermediate state from the state 1, the fixed contact 57 and the movable contact 58 are welded to each other because both contacts are adhered by their contact while the material of the above-mentioned surfaces thereof remains melted due to heat of the arc. Further, when the above-mentioned welding occurs, a second problem arises in that the switch stops moving and becomes inoperative, or the switch becomes heavier such that a great force is needed to operate the switch.

Based on FIGS. 13A to 13C, the cause of the above-mentioned first and second problems arising will be described. FIGS. 13A to 13C are schematic views illustrating only the essential part of the above-mentioned switch structure; FIG. 13A corresponds to the state 1 illustrated in FIGS. 12A and 12B, FIG. 13B corresponds to the state 4, and FIG. 13C corresponds to the state 7. Note that, in FIGS. 13A to 13C, a locus L is illustrated as a virtual arc which is symmetrical with a center line C in order to clearly show a rotation of the sliding member 51. Namely, the sliding member 51 is connected to the bottom portion of the operation button 53 by a spring with elasticity (not illustrated in FIGS. 13A to 13C) whereby it is not a rigid body which is movable only in the rotation direction with the shaft S as the rotation center thereof, but extensible in the vertical direction (direction from the fulcrum R to the shaft S in FIG. 13B). Therefore, the locus L depicted by the tip end of the sliding member 51 is actually a roughly straight line in the horizontal direction, that is, a direction orthogonal to the above-mentioned vertical direction on the plane shown in FIGS. 13A to 13C.

As illustrated in FIGS. 13A to 13C, the cause of the conventional switch having the above-stated first problem and second problem is that the rotation of the movable member 52 accompanied by a switching operation of the switch and the sliding of the sliding member 51 are linearly interlocked where an operation quantity of the switch and a distance that the sliding member 51 slides are in a proportional relationship. In addition, the cause of the sliding of the sliding member 51 linearly depending on the switching operation of the switch is that the position of the above-mentioned tip end on the sliding contact portion E when elastic deformation of the above-mentioned spring is maximum is located on a straight line P which connects the fulcrum R and the shaft S coinciding with the straight line P, whereby a moment of force applied to the movable member 52 by the sliding member 51 uniformly acts in the direction that the both contacts are contacted with each other and the direction that they are separated from each other in conjunction with the sliding movement of the sliding member 51 (namely, in conjunction with the switching operation of the switch).

Specifically, as the tip end of the sliding member 51 gets closer to the fulcrum R, the force which makes the both contacts contacted with each other is gradually weakened whereby the movable contact 58 separates from the fixed contact 57 little by little (i.e., state 2 and state 3 in FIG. 12A or 12B). Once the position of the above-mentioned tip end at the sliding contact portion E is located on the straight line P (state 4 in which elastic deformation of the above-mentioned spring is maximum), the above-mentioned moment of force is zero, accordingly, no force is acted in the direction that the both contacts are contacted with each other nor the direction that they are separated from each other. Once the above-mentioned position passes the straight line P (state 5 and state 6), force which separates the both contacts is gradually strengthened by a stress (i.e., a force that the above-mentioned elastic member tries to return to its original shape) stored by the elastic deformation of the above-mentioned spring whereby the movable contact 58 further separates from the fixed contact 57 little by little. In this way, the above-mentioned intermediate state appears according to the switching operation of the switch until the switch is shifted from the state 1 to the state 7 (refer to FIGS. 12A and 12B). This causes the above-mentioned first and second problems.

As previously mentioned, in above-mentioned Japanese Unexamined Patent Publication No. 2012-198993, the seesaw switch in which an operation speed and an opening and closing speed of a contact thereof are separated is disclosed. However, the seesaw switch needs to include a complicated configuration in which a second touch piece which is a different part from a first touch piece is provided to the first touch piece, and consequently, the number of parts increases while causing a disadvantage that the number of processes for assembling the parts also increases. In the other patent documents as well, the same disadvantage occurs, and therefore, it is difficult to be practically used in view of reducing costs.

### SUMMARY

The present invention has been made considering the above-mentioned first and second problems, and provides a switching device in which a sliding of a sliding member does not depend on a switching operation through a simple configuration.

A switching device including a movable member configured to swing around a predetermined fulcrum, a movable contact provided on the movable member, a sliding member of which a predetermined part slides on a predetermined surface of the movable member by a movement of rotating around a predetermined shaft, an elastic member configured to support the sliding member so as to be slidable while the predetermined part remains abutted on the predetermined surface, and a fixed contact configured to be contacted with the movable contact in a predetermined contact position, where the movable member swings by a sliding of the sliding member, thereby switching a contact and a noncontact of the movable contact and the fixed contact so as to switch a conduction and a break of an electricity, and where the sliding member is configured to rotate so that a deformation of the elastic member is maximum in a position of the predetermined part on the predetermined surface, the position being deviated to a side of the predetermined contact position compared to a straight line which connects the predetermined shaft and the predetermined fulcrum. Thereby, the above-mentioned switching device can make it possible that a slide of a sliding member does not depend on a switching operation through a simple configuration thereof. Therefore, the above-mentioned switching device takes an effect of being capable of solving the first problem that the lifetime of the switch is shortened by an arc and the second problem that operations become impossible or become heavy due to contacts welding.

### BRIEF DESCRIPTION OF THE DRAWINGS

FIG. 1 is a schematic view illustrating the main portion structure according to one aspect of the present invention;

FIGS. 2A to 2C are schematic views illustrating only the essential part of a first structure that a shaft is closer to a contact position than a fulcrum; FIG. 2A corresponds to a state 1 illustrated in FIGS. 5A and 5B, FIG. 2B corresponds to a state 4, and FIG. 2C corresponds to a state 7;

FIGS. 3A to 3C are schematic views illustrating only the essential part of a second structure that a sliding projection is provided to a sliding portion of a movable member; FIG. 3A corresponds to the state 1 illustrated in FIGS. 5A and 5B, FIG. 3B corresponds to the state 4, and FIG. 3C corresponds to the state 7;

FIG. 4 is a schematic view illustrating the main portion structure of an internal portion of the above-mentioned switch;

FIGS. 5A and 5B are schematic views illustrating how the above-mentioned switch operates in time series; FIG. 5A illustrates how a fixed contact and a movable contact are contacted with each other and separated from each other in conjunction with a sliding of a sliding member, FIG. 5B enlarges a part that a tip end of the sliding member slides on the sliding portion and also indicates a direction of force applied by the sliding member with an allow;

FIGS. 6A to 6C are exploded perspective views illustrating an assembly process of the above-mentioned switch stepwise; FIG. 6A illustrates a first assembly process, FIG. 6B illustrates a second assembly process, and FIG. 6C illustrates an appearance of the above-mentioned switch of which the assembly is finished;

FIGS. 7A to 7C illustrate the movable member; FIG. 7A is a side view, FIG. 7B is a bottom view, and FIG. 7C is a perspective view;

FIG. 8 is a table which compares break time and arc energy between the above-mentioned switch and a conventional switch by two types of operation speed;

FIG. 9A is a graph illustrating dependency on operation speed of break time, and FIG. 9B is a graph illustrating dependency on operation speed of arc energy;

FIGS. 10A to 10C are schematic views illustrating other shapes of the sliding projection provided to the movable member; FIG. 10A is a first other shape, FIG. 10B is a second other shape, and FIG. 10C is a third other shape;

FIG. 11 is a schematic view illustrating the main portion structure of an internal portion of a conventional switch;

FIGS. 12A and 12B are schematic views illustrating how the above-mentioned conventional switch operates in time series; FIG. 12A illustrates how a fixed contact and a movable contact are contacted with each other and separated from each other in conjunction with a sliding of a sliding member, FIG. 12B enlarges a part that a tip end of a sliding member slides on a sliding portion and also indicates a direction of force applied by the sliding member with an allow; and

FIGS. 13A to 13C are schematic views illustrating only the essential part of the structure of the above-mentioned conventional switch; FIG. 13A corresponds to a state 1 illustrated in FIGS. 12A and 12B, FIG. 13B corresponds to a state 4, and FIG. 13C corresponds to a state 7.

### DETAILED DESCRIPTION

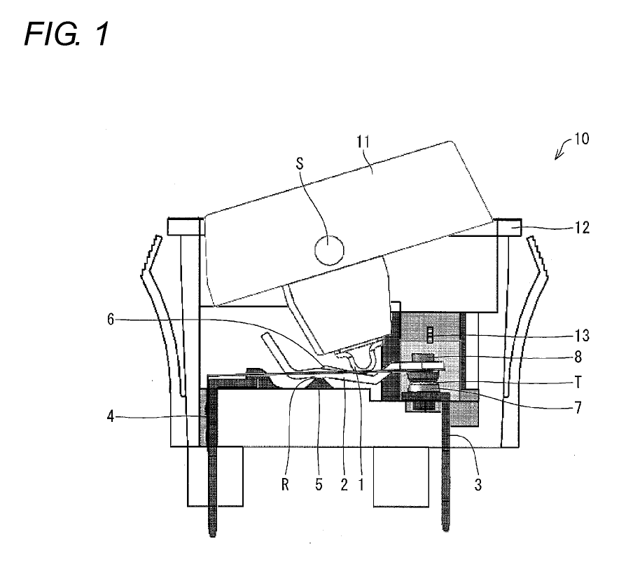

Based on FIG. 1 to FIG. 10C, one embodiment of the present invention will be specifically described.

Based on FIG. 1, a configuration of a switch 10 will be described. FIG. 1 is a cross sectional view illustrating an internal structure of the switch 10.

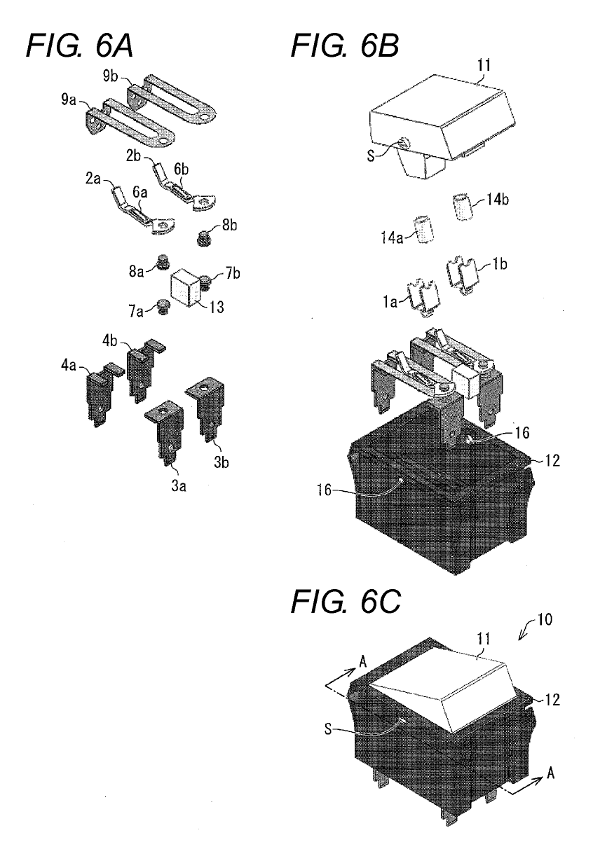

Note that a relation between the whole switch 10 and a cross section illustrated by FIG. 1 will be described later referring to FIG. 6C. Further, although the switch 10 includes two identical members which are indicated with reference signs 1 to 9, and 14, only one of the pair thereof are shown in a cross sectional view illustrated in FIG. 1. In FIGS. 6A to 6C and the description of FIGS. 6A to 6C, it is clearly specified that two of the above-mentioned members exist by further adding a or b to the above-mentioned reference signs, while addition of a and b is omitted in other drawings and descriptions of the other drawings in order to secure simplicity of descriptions. In other drawings and descriptions of the other drawings, a member indicated with a sign without a and b corresponds to either of members which are indicated with the addition of a or b to the above-mentioned reference signs in FIGS. 6A to 6C and descriptions of FIGS. 6A to 6C (for example, a sliding member 1 in other drawings corresponds to a sliding member 1a or a sliding member 1b in FIG. 6A).

A switch 10 is a switching device including a movable member 2 which swings around a casing projection 5 as a fulcrum R, a movable contact 8 which is provided on the movable member 2, a sliding member 1 whose tip end slides on a sliding contact portion E of the movable member 2 by a movement of rotating around a shaft S, a spring or elastic member 14 which extensively supports the sliding member 1 so that it can slide while the tip end thereof remains abutted to the sliding contact portion E, and a fixed contact 7 which is contacted with the movable contact 8 in a contact position T, in which the movable member 2 slides by a sliding of the sliding member 1 and contact and noncontact of the movable contact 8 and the fixed contact 7 are switched by a swinging of the movable member 2, and thereby switching conduction and break of electricity. As illustrated in FIG. 1, the switch 10 includes the sliding member 1, the movable member 2, a fixed member 3, a grounding member 4, the casing projection 5, a sliding projection 6, the fixed contact 7, the movable contact 8, an operation button 11, and a magnet 13.

The movable member 2 is a member with a substantially spoon-like shape, that is, a shape in which a fan-shaped dish-like part is provided on one end portion thereof, and a plate-shaped member extends from the central portion of the fan like a spoon handle. The moveable member 2 is made using a nonmagnetic material such as stainless (for example, stainless such as SUS304, etc.) or the like. The movable member 2 includes the movable contact 8 (a conductive member made using silver alloy) on the above-mentioned dish-like part thereof, and the other end portion of the movable member 2 (an end portion of the above-mentioned plate-shaped member) is curved in a semi-hook shape.

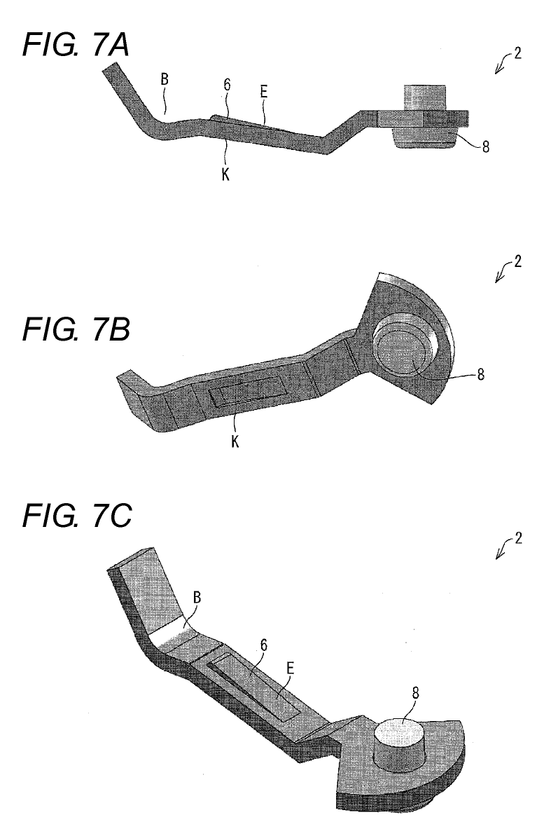

The movable member 2 is supported by the casing projection 5 so that the casing projection 5 is inserted into a recess K (not shown in FIG. 1, and will be described later in detail referring to FIGS. 7A and 7B) on the rear surface (a surface of the above-mentioned plate-shaped member on the side that the movable contact 8 is contacted with the fixed contact 7) of the movable member 2, and thereby the movable member 2 swings around the fulcrum R like a seesaw around the casing projection 5. The movable member 2 is curved also at its substantially central portion so as to be warped with respect to the casing projection 5. Namely, the above-mentioned plate-shaped member which extends like a spoon handle having the curves at the other end portion and the substantially central portion draws a smooth substantial letter S shape. Note that the curved part formed with the above-mentioned substantial letter S shape is called “curved portion B”, hereunder (see, FIGS. 7A to 7C).

On the other hand, the sliding projection 6 is provided on the front surface (a surface of the above-mentioned plate-shaped member on the side opposite to the above-mentioned rear surface) of the movable member 2, and the tip end of the sliding member 1 slides (to move while the tip end of the sliding member 1 remains contacting with the front surface) on the above-mentioned front surface while running on the sliding projection 6. Note that the part on which the sliding member 1 slides on the front surface is called “sliding portion E” hereafter.

The fixed member 3 is a member with a hook shape which is made using brass (for example, brass such as C2680R or the like will do). The fixed member 3 includes the fixed contact 7 (i.e., a conductive member made using silver alloy) in a hook part thereof. A handle part of the fixed member 3 is buried in the bottom surface of a casing 12 which is made using a synthetic fiber such as nylon 66, etc., and an electric wire capable of conducting electricity is connected to the tip of the handle part. Likewise, the grounding member 4 is also a member with a hook shape which is made using brass (C2680R). As for the grounding member 4 as well, a handle part thereof is buried in the bottom surface of the casing 12, and an electric wire capable of conducting electricity is connected to the tip of the handle part.

The sliding member 1 is a member with a shape of a plate-shaped member that is curved in a semicircular shape which is made using a nonmagnetic material such as stainless (for example, stainless such as SUS304, etc.) or the like. The sliding member 1 is extensively attached to the bottom portion of the operation button 11 (which is made using a synthetic fiber such as nylon 66, etc.) via a spring 14 (see, FIGS. 6A to 6C). Therefore, when a shaft S is rotated by operating the operation button 11, the sliding member 1 also rotates about the shaft S in conjunction with the rotation. The tip end of the sliding member 1 slides on the sliding contact portion E of the movable member 2 by the rotation, then the movable member 2 swings around the fulcrum R in conjunction with the sliding. By the swing, the movable contact 8 which is provided on one end portion of the movable member 2 is contacted with and separated from the fixed contact 7, and therefore, the switch 10 can switch between conduction and break of electricity.

Additionally, it is preferable that a curvature of the curved portion B and a curvature of the shape curved in the above-mentioned semicircular shape are substantially identical so that the curved portion B can receive the tip of the sliding member 1 which has slid on the sliding portion E running on the sliding projection 6 from the side of the contact position T. However, the both curvatures do not need to be substantially identical.

The magnet 13 is a neodymium-bonded magnet (i.e., a neodymium plastic magnet) with a rectangular shape provided in order to promote diffusion of an arc by generating a magnetic field in a direction orthogonal to a direction that electrical currents move and applying force to electrons which generate the arc.

### Two Characteristic Structures Provided to the Switch 10

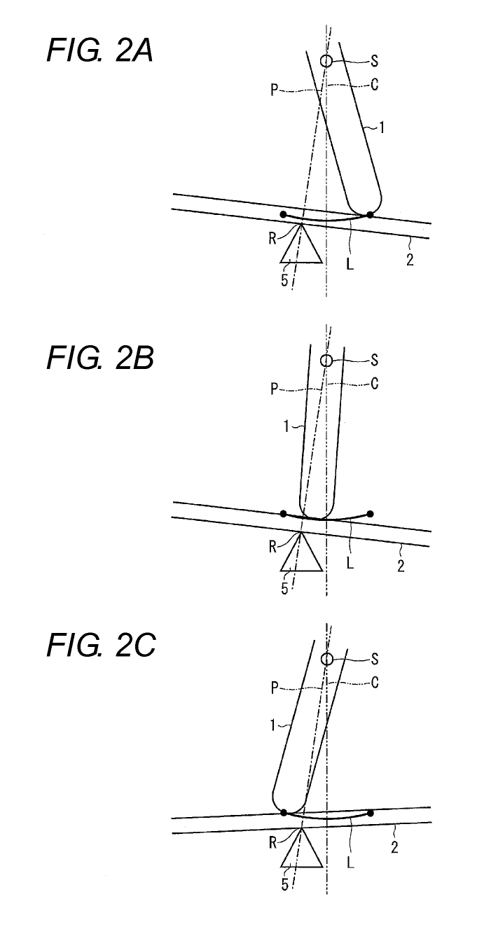

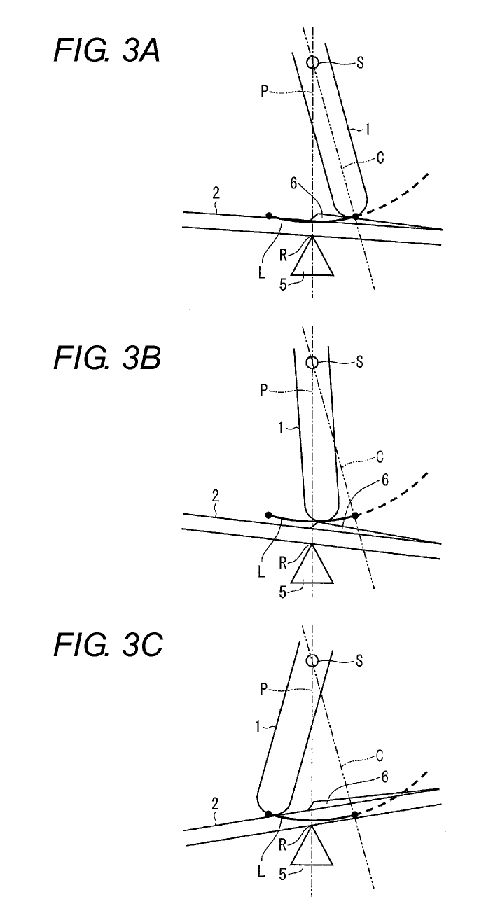

Two characteristic structures employed in the switch 10 in order to solve the above-mentioned first problem that the lifetime of the switch is shortened by an arc and second problem that operations become impossible or become heavy due to contacts welding, will be described based on FIGS. 2A to 2C and FIGS. 3A to 3C. FIGS. 2A to 2C are schematic views illustrating only the essential part of the first structure that the shaft S is closer to the contact position T than the fulcrum R. FIG. 2A corresponds to the state 1 illustrated in FIGS. 5A and 5B, FIG. 2B corresponds to the state 4, and FIG. 2C corresponds to the state 7. Likewise, FIGS. 3A to 3C are schematic views illustrating only the essential part of the second structure that the sliding projection 6 is provided to the sliding portion E of the movable member 2. FIG. 3A corresponds to the state 1 illustrated in FIGS. 5A and 5B, FIG. 3B corresponds to the state 4, and FIG. 3C corresponds to the state 7. Note that FIGS. 5A and 5B will be described in detail later.

As illustrated in FIGS. 2A to 2C, the horizontal position of the shaft S is deviated to the side of the contact position T with respect to the fulcrum R. The shaft S is closer to the contact position T than the fulcrum R. Thereby the position of the tip end of the sliding member 1 on the sliding contact portion E when elastic deformation of the spring 14 (refer to FIG. 6B) is maximum is not located on the straight line P (not coinciding with the straight line P). Namely, deformation of the spring 14 is maximum in the position which is deviated to the side of the contact position T compared to the straight line P. Thereby, energy of the spring 14 is released in the position of the straight line P where moment is neutral, then the tip end of the sliding member 1 slides on the sliding contact portion E with the energy stored in the spring 14.

As illustrated in FIGS. 3A to 3C, the sliding projection 6 is provided to the sliding contact portion E of the movable member 2, and thereby the position of the above-mentioned tip end on the sliding contact portion E when elastic deformation of the spring 14 is maximum is not located on the straight line P (not coinciding with the straight line P). Namely, the tip end of the sliding member 1 slides in a manner of going up a slope of the sliding projection 6, and thereby the position that elastic deformation of the spring 14 is maximum at the top of the sliding projection 6 is deviated to the side of the both contacts (the fixed contact 7 and the movable contact 8) compared to the straight line P. Thereby, energy of the spring 14 is released in the position of the straight line P where moment is neutral, then the tip end of the sliding member 1 slides on the sliding contact portion E with the energy stored in the spring 14.

Note that, in FIGS. 2A to 2C and FIGS. 3A to 3C, the locus L is illustrated as a virtual arc which is symmetrical with the center line C in order to clearly describe the effect caused by providing the above-mentioned first and second structures respectively. Namely, the sliding member 1 is actually not a rigid body which is movable only in the rotation direction around the shaft S as the rotation center thereof, but extensible in the vertical direction (direction from the fulcrum R to the shaft S in FIG. 2B or FIG. 3B) due to elasticity of the spring 14. Therefore, the locus L drawn by the tip end of the sliding member 1 is not a virtual arc as illustrated in FIGS. 2A to 2C or FIGS. 3A to 3C. However, the essence “the position of the above-mentioned tip end on the sliding contact portion E when elastic deformation of the spring 14 is maximum is not located on the straight line P” is not changed in the actual switch 10 as well.

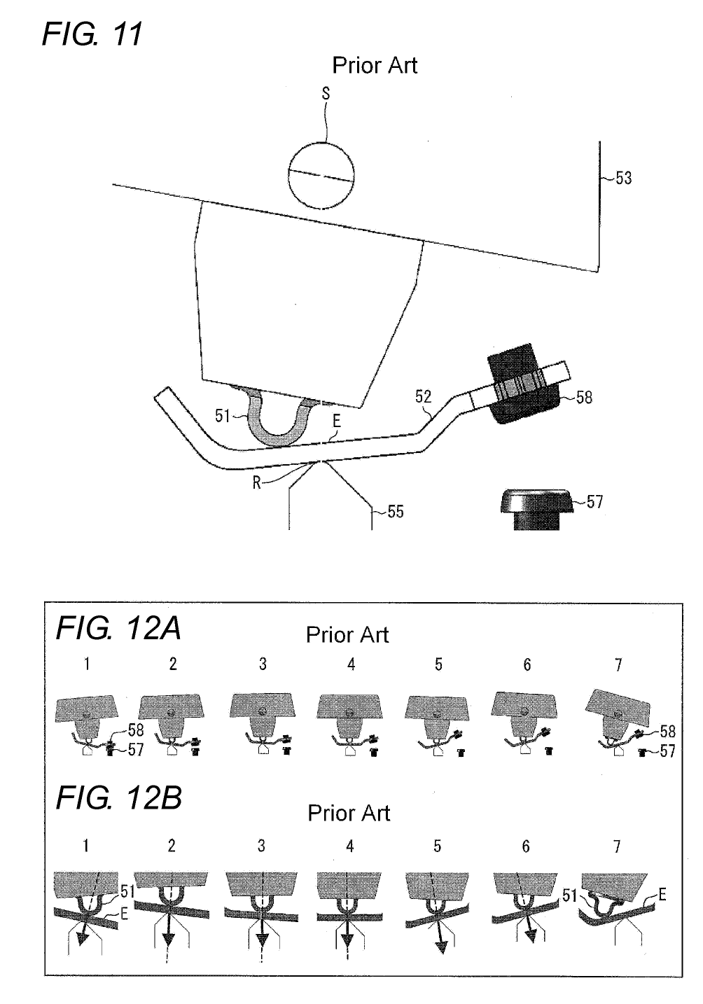

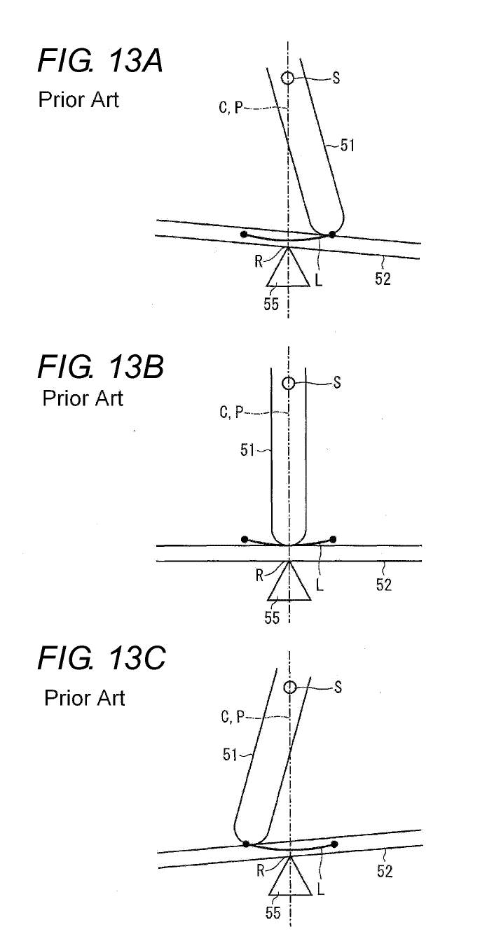

As previously described, in the conventional switch (refer to FIG. 11 to FIG. 13C), the position of the sliding member on the sliding contact portion E when the elastic deformation of the spring is maximum is located on the straight line P which connects the fulcrum R and the shaft S. Thereby, the moment of force applied to the movable member by the sliding member uniformly acts in the direction that the both contacts are contacted with each other and the direction that they are separated from each other in conjunction with the sliding movement of the tip end of the sliding member on the sliding contact portion E. Therefore, the intermediate state (a state in which the fixed contact 7 and the movable contact 8 are close to each other) appears successively until the conventional switch is shifted from the state 1 to the state 7. This causes the above-mentioned first and second problems.

On the other hand, the switch 10 includes (1) the first structure (FIGS. 2A to 2C) that the horizontal position of the shaft S is deviated to the side of the contact position T with respect to the fulcrum R or (2) the second structure (FIGS. 3A to 3C) that the sliding projection 6 is provided to the sliding contact portion E of the movable member 2, and therefore, the sliding member 1 rotates so that deformation of the spring 14 is maximum in the position of the tip end of the sliding member 1 on the sliding contact portion E, the position being deviated to the side of the contact position T compared to the straight line P. The sliding member 1 rotates so that the position of the above-mentioned tip end on the sliding contact portion E when elastic deformation of the spring 14 is maximum is not located on the straight line P. Thereby, a moment of force applied to the movable member 2 by the sliding member 1 acts while deviating to the direction that the both contacts are contacted with each other.

Specifically, as the tip end of the sliding member 1 gets closer to the fulcrum R, the force which makes the both contacts contacted with each other is gradually weakened, however, the movable contact 8 is not separated from the fixed contact 7 until the above-mentioned tip end passes the straight line P, unlike in the conventional switch. This is because the position that deformation of the spring 14 is maximum is deviated to the side of the contact position T compared to the straight line P, and thereby, the above-mentioned moment of force is still applied in the direction that the both contacts are contacted with each other even when the above-mentioned tip end comes to the position that deformation of the spring 14 is maximum (the state 4 illustrated in FIGS. 5A and 5B). Namely, the switch 10 can delay the timing of the both contacts thereof being separated compared to the conventional case by including the above-mentioned structure (1) or (2) in that the sliding member does not start sliding at the same time when the switching operating is started as in the conventional case. Thereby, both contacts are still contacted with each other in the step that an operation is half way performed, and therefore, both contacts are not welded to each other even when the operation is returned. Accordingly, the switch 10 can solve the above-mentioned second problem.

Further, when elastic deformation of the spring 14 is maximum, the movable contact is already separated from the fixed contact in the conventional switch, whereas, in the switch 10, on the other hand, the movable contact 8 is still not separated from the fixed contact 7. Thereby, the switch 10 can apply the stress (i.e., force that the spring 14 tries to return to its original shape) which is stored by deformation of the spring 14 in the direction that the both contacts are separated from the state that the both contacts are still contacted with each other. Therefore, in the switch 10, when the separation of the both contacts of which timing is delayed starts, the movable contact 8 is separated from the fixed contact 7 at higher speed than in a conventional case so that the both contacts are completely opened immediately. The speed of the movable contact separating from the fixed contact does not depend on the speed of the switch being operated as in the conventional case. Thereby, the time of the above-mentioned intermediate state in which an arc occurs is shorter than in the conventional case, and therefore, the switch 10 can solve the above-mentioned first problem.

As stated above, the switch 10 can make it possible that a slide by the sliding member 1 does not depend on a switching operation through a simple configuration of the above-mentioned first and second structures. Therefore, the switch 10 can solve the first problem that the lifetime of the switch is shortened by an arc and the second problem that operations become impossible or become heavy due to a welding of the fixed contact 7 and the movable contact 8.

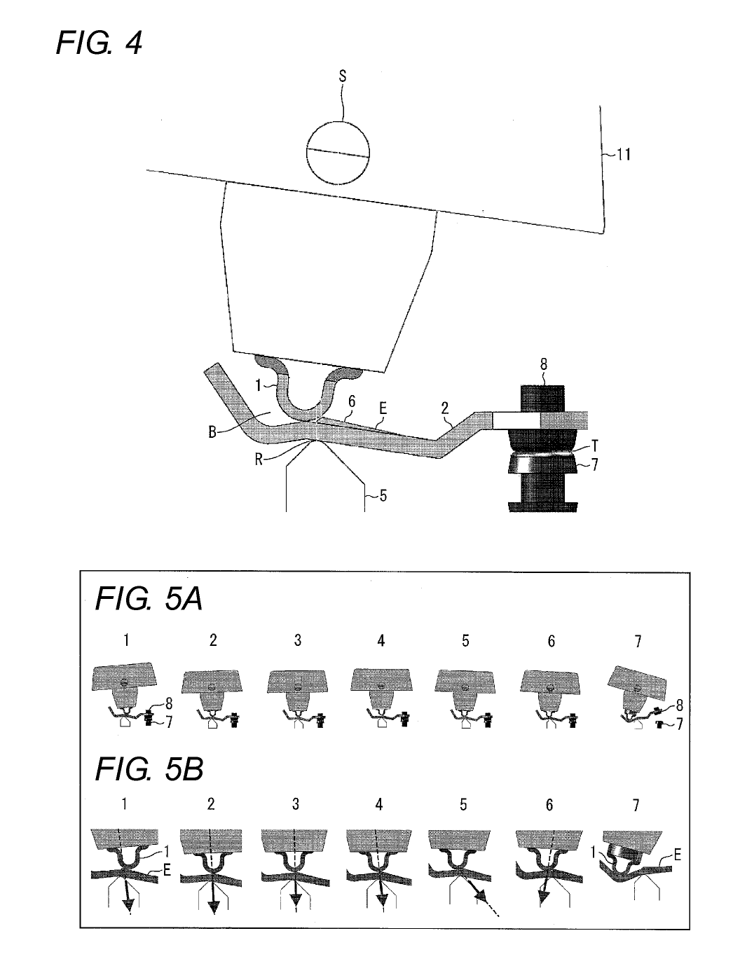

Note that the switch 10 with the above-mentioned first and second structures will be described in FIG. 1, FIG. 4 to FIG. 10C and the descriptions of the drawings. The switch 10 includes the both structures, which can solve the above-mentioned first and second problems more surely because it is possible that a sliding of the sliding member 1 further does not depend on a switching operation. However, note that the same effect is caused even when the switch 10 includes only either one of the structures. Further, also note that, in order to make the moment of force which is applied to the movable member 2 by the sliding member 1 act while deviating to the direction that the both contacts are contacted with each other, the structure in which the sliding member 1 rotates so that deformation of the spring 14 is maximum in the position of the tip end of the sliding member 1 on the sliding contact portion E, the position being deviated to the side of the contact position T compared to the straight line P will do, and the structure is not limited to the above-mentioned first or second structure.

### Operation of Switch 10

Based on FIG. 4 and FIGS. 5A and 5B, the structure that the switch 10 has and operations of the switch 10 will be described in detail. FIG. 4 is a schematic view illustrating the main portion structure of the internal portion of the switch 10. FIGS. 5A and 5B are schematic views illustrating how the switch 10 operates in time series; FIG. 5A illustrates how the fixed contact 7 and the movable contact 8 are contacted and separated in conjunction with a sliding of the sliding member 1, FIG. 5B enlarges a part that the tip end of the sliding member 1 slides on the sliding portion E and also indicates a direction of force applied by the sliding member 1 with an allow. Note that, in FIGS. 5A and 5B, the schematic views are called “state 1” to “state 7” in order from left to right in the schematic view.

As illustrated in FIG. 4, the switch 10 includes the first structure that the shaft S is closer to the contact position T than the fulcrum R and the second structure that the sliding projection 6 is provided to the sliding contact portion E of the movable member 2. Now, note that the curved portion B is formed by the movable member 2 having a substantial letter S shape.

In the conventional switch, the movable member thereof only includes a plate-shape (the substantially central portion is not curved in a warping manner with respect to the casing projection, thereby not having a substantial letter S shape), and therefore, the sliding speed of the sliding member is not made faster or slower in accordance with the shape of the sliding contact portion E. Namely, the operation speed of the switch and the sliding speed of the sliding member (the speed of the movable contact separating from the fixed contact, in other word) coincide with each other. Therefore, a sliding of the sliding member further depends on a switching operation of the switch.

On the other hand, since the movable member 2 provided to the switch 10 includes the curved portion B, the tip end of the sliding member 1 which has slid on the sliding contact portion E from the side of the contact position T slides at once toward the curved portion B in a manner of going down the downward slope from the top of the sliding projection 6 to the lowest portion of the above-mentioned curved portion B, once it climbs over the sliding projection 6 (refer to the state 7 in FIGS. 5A and 5B). Namely, after the sliding member 1 goes through the top of the sliding projection 6, the sliding member 1 slides at high speed not depending on the speed that the operation button 11 is pressed (i.e., the speed that the switch 10 is operated). Thereby, the movable member 2 energetically swings in a hopping manner, and therefore, the movable contact 8 is separated from the fixed contact 7 at high speed. In other words, when the separation of the both contacts of which timing is delayed starts (state 6), the switch 10 is immediately shifted to the state in which they are completely opened (state 7). Thereby, the time of the above-mentioned intermediate state in which an arc occurs is shorter than in a conventional case, and therefore, the switch 10 can further surely solve the above-mentioned first problem.

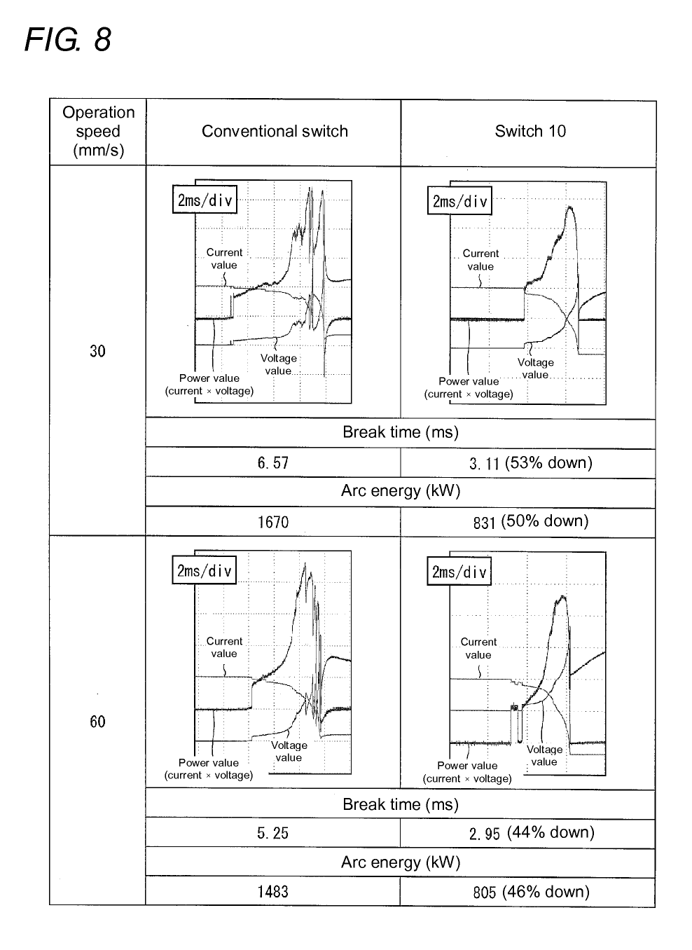

Furthermore, the switch 10 can make the casing 12 smaller compared to the conventional switch. This is because, in the conventional switch, it is needed to make the casing larger than a predetermined size so as to take the internal space thereof widely to some extent in order to prevent the inner wall of the casing from deteriorating due to an arc, the switch 10, on the other hand, can suppress energy of occurring arcs to be small by separating the movable contact 8 from the fixed contact 7 at high speed (will be described later in detail referring to FIG. 8), and therefore, the internal space thereof does not need to be wide.

As illustrated in FIGS. 5A and 5B, even though the tip end of the sliding member 1 approaches the other end portion of the movable member 2, the movable contact 8 is not separated from the fixed contact 7 until reaching the position illustrated in the state 6. This is because, as can be seen from the direction of force which is indicated by an arrow in FIG. 5B, the force is always applied in the direction that the both contacts are contacted with each other. Further, after the sliding member 1 reaches the position illustrated in the state 6, the above-mentioned tip end immediately slides up to the position illustrated in the state 7 (the lowest portion of the curved portion B). Thereby, the switch 10 is shifted from the state in which the fixed contact 7 and the movable contact 8 are contacted with each other (state 1) to the state in which the both contacts are separated from each other (state 7) at once with substantially no experience of the intermediate state in which the fixed contact 7 and the movable contact 8 are close to each other.

Namely, the switch 10 can make it possible that a slide by the sliding member 1 does not depend on a switching operation through the simple configuration thereof. Accordingly, the switch 10 can solve the above-mentioned first and second problems.

### Appearance of Switch 10 and Assembly Process Thereof

Based on FIGS. 6A to 6C, the appearance of the switch 10 and the assembly process thereof will be described. FIGS. 6A to 6C are the exploded perspective views illustrating the assembly process of the switch 10 stepwise; FIG. 6A illustrates the first assembly process, FIG. 6B illustrates the second assembly process, and FIG. 6C illustrates the appearance of the switch 10 of which the assembly is finished. Note that the previously described FIG. 1 corresponds to an A-A line cross sectional view with respect to the arrowed direction in FIG. 6C. Hereunder, only members which are not shown in the cross section illustrated in FIG. 1 will be described.

A bridge 9a and a bridge 9b are members, each having a hook shape which conducts electricity from the side of the fixed member 3 to the side of the grounding member 4 (the direction of electric current may be reversed) when the fixed contact 7 and the movable contact 8 are contacted with each other, being made using brass. Namely, the hook parts of the bridge 9a and the bridge 9b are fixed to a grounding member 4a and a grounding member 4b respectively, and when the movable member 2 swings so that the both contacts are contacted with each other, handle parts of the bridge 9a and the bridge 9b are contacted with the fixed member 3a and the fixed member 3b respectively in such a pressing manner. Thereby, electricity is conducted from the side of the fixed member 3 to the side of the grounding member 4.

A spring 14a and a spring 14b are columnar elastic members, each extensively connecting a sliding member 1a and a sliding member 1b to the bottom portion of the operation button 11 so that the tip end of the sliding member 1 is capable of sliding while it remains abutted to the sliding contact portion E, being made using a piano wire (for example, a piano wire of steel wire such as SWP-A, etc. will do). A bearing hole 16a and a bearing hole 16b are holes which enable the operation button 11 to rotate by inserting a projection, which is provided to the operation button 11 and acts as the shaft S, thereinto.

### Form of Movable Member 2

Based on FIGS. 7A to 7C, the form of the movable member 2 will be described in detail. FIGS. 7A to 7C illustrate the movable member 2; FIG. 7A is the side view, FIG. 7B is the bottom view, and FIG. 7C is the perspective view.

As illustrated in FIGS. 7A and 7B, the recess K is provided to the back surface of the movable member 2, and the movable member 2 is mounted on the casing projection 5 in such a manner that the casing projection 5 is inserted into the recess K in such a manner that the deepest portion of the recess K is abutted to the tip end of the casing projection 5. Thereby, the movable member 2 is supported so as to swing around the casing projection 5 as the fulcrum R.

As illustrated in FIGS. 7A and 7C, the movable member 2 includes the curved portion B which is formed by the semi-hook shape of the other end portion which is the end portion opposite to the end portion with the movable contact 8. Thereby, the sliding member 1 which has slid on the sliding contact portion E from the side of the contact position T slides at once toward the curved portion B once it climbs over the sliding projection 6, then the movable member 2 energetically swings in a hopping manner, and therefore, the movable contact 8 is separated from the fixed contact 7 at high speed.

### Comparison Between Performance of Switch 10 and Performance of Conventional Switch

Based on FIG. 8, the result of the comparison between the performance of the switch 10 and the performance of the conventional switch will be described. FIG. 8 is a table which compares break time, which is required since an arc occurs after a separation of a fixed contact and a movable contact until the arc disappears, and electric energy discharged by the arc between the switch 10 and the conventional switch by two types of operation speeds. In a graph included in the table, the abscissa shows the time that has elapsed since an arc occurs, and the ordinate shows the amount of electric current, voltage, and electric power (electric current by voltage) of the arc in each time.

As shown by the abscissa in each graph of FIG. 8, the time since an operation of the operation button starts until the movable contact 8 starts separating from the fixed contact 7 (a millisecond) is longer in the switch 10 than in the conventional switch. Namely, the switch 10 can delay the timing that the movable contact 8 is separated from the fixed contact 7 compared to the conventional case. Further, as illustrated in each graph, rising of a waveform which shows arc energy is steeper in the switch 10 than in the conventional switch. Namely, the switch 10 can shorten the time that an arc occurs than the conventional switch by separating the movable contact 8 from the fixed contact 7 at high speed.

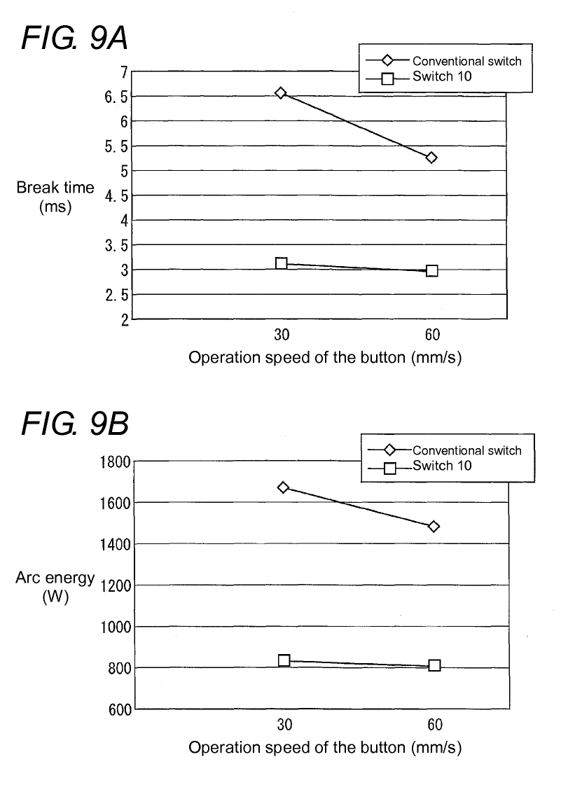

Actually, break time is shorter and arc energy is smaller in the switch 10 than in the conventional switch in both of the operation speeds of 30 mm per second and 60 mm per second. Note that as described later referring to FIGS. 9A and 9B, in the conventional switch, the slower the operation speed is, the more the break time and the arc energy increase, having dependency on operation. In the switch 10, on the other hand, the break time and the arc energy are maintained substantially constant, having no dependency on operation. Therefore, the slower the operation speed of the conventional switch is, the larger the rate of decline of the break time and the arc energy of the switch 10 with respect to the conventional switch is.

Based on FIGS. 9A and 9B, the result of further comparing the performance of the switch 10 and the performance of the conventional switch will be described. FIG. 9A is a graph illustrating the dependency of break time on operation speed, and FIG. 9B is a graph illustrating the dependency of arc energy on operation speed.

As illustrated in FIGS. 9A and 9B, the inclination of each straight line connecting two points which show the experiment results of the switch 10 is remarkably smaller than the inclination of corresponding straight line connecting two points which show the experiment results of the conventional switch. This shows that the switch 10 always exhibits a constant effect, where an effect obtained does not depend on operation speed, as compared with the conventional switch. Namely, the switch 10 can delay the timing that the movable contact 8 is separated from the fixed contact 7 and also separate the movable contact 8 from the fixed contact 7 at high speed without depending on the speed of pressing the operation button 11.

Therefore, the switch 10 can surely solve the first problem that the lifetime of the switch is shortened by an arc and the second problem that operations become impossible or become heavy due to a welding of the fixed contact 7 and the movable contact 8.

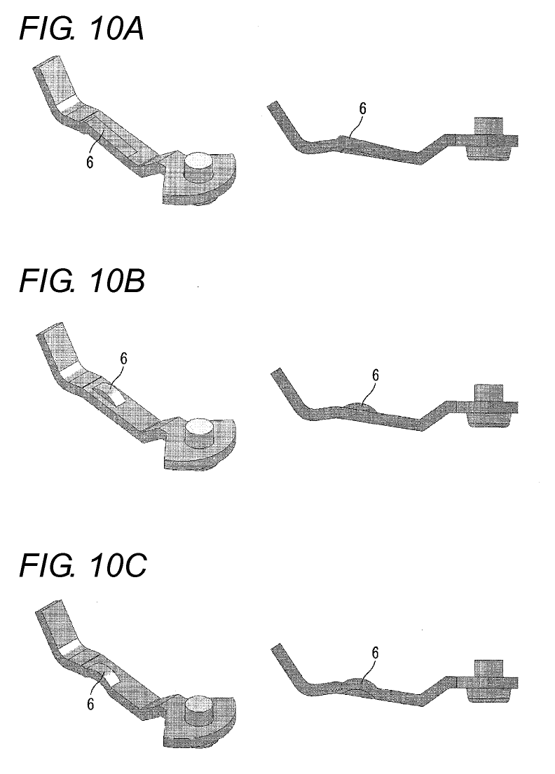

Based on FIGS. 10A to 100, other shapes of the sliding projection 6 will be described. FIGS. 10A to 100 are schematic views illustrating other shapes of the sliding projection 6 provided to the movable member 2; FIG. 10A is a first other shape, FIG. 10B is a second other shape, and FIG. 10C is a third other shape.

As illustrated in FIG. 10A, the sliding projection 6 may be provided to the foreside of the movable member 2 (i.e., the side surface of the casing 12 in the appearance of the switch 10 illustrated in FIG. 6C). Additionally, as illustrated in FIG. 10B, the sliding projection 6 may have a dome shape. Or, as illustrated in FIG. 10C, the sliding projection 6 with a dome shape may be provided to the foreside of the movable member 2.

As described above referring to FIG. 1 to FIG. 10C, the switch 10 can make it possible that a sliding of the sliding member 1 does not depend on a switching operation through the simple configuration. Specifically, the switch 10 delays the timing that the movable contact 8 is separated from the fixed contact 7 and also makes it possible that the both contacts are separated at high speed regardless of how the operation button 11 is operated. Therefore, the switch 10 exhibits the effect that it can solve the first problem that the lifetime of the switch is shortened by an arc and the second problem that operations become impossible or become heavy due to a welding of the contacts.

Additionally, the switch 10 also exhibits the effect that it can be smaller than the conventional switch. Because, the movable contact 8 is separated from the fixed contact 7 at high speed, and thereby occurring arc energy can be suppressed to be small, thus, the internal space of the casing 12 does not need to be wide.

The present invention can be applied widely to a switching device which switches conduction and break of electricity.

A switching device is herein disclosed including a movable member configured to swing around a predetermined fulcrum; a movable contact provided to the movable member; a sliding member of which a predetermined part slides on a predetermined surface of the movable member by a movement of rotating around a predetermined shaft; an elastic member configured to extensively support the sliding member so as to be slidable while the predetermined part remains abutted on the predetermined surface; and a fixed contact configured to be contacted with the movable contact in a predetermined contact position, in which the movable member swings by a sliding of the sliding member, thereby switching a contact and a noncontact of the movable contact and the fixed contact so as to switch a conduction and a break of an electricity, and (2) the sliding member is configured to rotate so that a deformation of the elastic member is maximum in a position of the predetermined part on the predetermined surface, the position being deviated to a side of the predetermined contact position compared to a straight line which connects the predetermined shaft and the predetermined fulcrum.

As previously mentioned, in conventional switches, the position of the sliding member on the predetermined surface when elastic deformation of the elastic member is maximum is located on the straight line which connects the predetermined fulcrum and the predetermined shaft. Thereby, the operation quantity of the switch and the distance that the sliding member slides are in a proportional relationship with each other, and thereby an arc shortens the lifetime of the switch and operations become impossible or become heavy due to contacts welding.

On the other hand, according to the switching device of one aspect of the present invention, the above-mentioned sliding member rotates so that the above-mentioned deformation of the elastic member is maximum in the position of the above-mentioned predetermined part (for example, the tip end of the above-mentioned sliding member) on the above-mentioned predetermined surface, the position being deviated to the side of the above-mentioned predetermined contact position compared to the above-mentioned straight line. According to the simple configuration in which the number of parts is not increased, a moment of force applied to the above-mentioned movable member by the above-mentioned sliding member acts while deviating to the direction that the above-mentioned fixed contact and the above-mentioned movable contact are contacted with each other.

Specifically, as the above-mentioned predetermined part gets closer to the above-mentioned predetermined fulcrum, the above-mentioned moment of force which acts in the direction that the both contacts are contacted with each other is gradually weakened, while the above-mentioned movable contact is not separated from the above-mentioned fixed contact until the above-mentioned predetermined part passes the above-mentioned straight line. Namely, when the deformation of an elastic member is maximum, a movable contact has already been separated from the fixed contact in the conventional switch, on the other hand, in the above-mentioned switching device, the above-mentioned movable contact is still not separated from the above-mentioned fixed contact. This is because the position that the above-mentioned deformation of the elastic member is maximum is deviated to the side of the above-mentioned predetermined contact position compared to the above-mentioned straight line, and thereby the above-mentioned moment of force is still added to the direction that the both contacts are contacted with each other even when the above-mentioned predetermined part comes to the maximum deformation position.

Accordingly, in the above-described switching device, the timing of the above-mentioned movable contact separating from the above-mentioned fixed contact is delayed compared to the conventional one (the sliding member does not start sliding at the same time when a switching operating is started as in the conventional case). Namely, since the both contacts are still contacted with each other in the step that an operation is half way performed (step that the above-mentioned stress of the elastic member starts acting), even when the operation is returned, the both contacts are not welded to each other.

Additionally, since the above-mentioned movable contact is not separated from the above-mentioned fixed contact even when the above-mentioned deformation of the elastic member is maximum, the above-mentioned switching device can apply the stress (force that the above-mentioned elastic member tries to return to its original shape) which is stored by the above-mentioned elastic deformation in the direction that the both contacts are separated from each other from the state that the both contacts are still contacted with each other. Therefore, in the above-mentioned switching device, when the separation of the both contacts of which timing is delayed starts, the above-mentioned movable contact is separated from the above-stated fixed contact at higher speed than the conventional case so that the both contacts are completely opened immediately (the speed of the movable contact separating from the fixed contact does not depend on the speed of the switch being operated as in the conventional case). Thereby, the time of the above-mentioned intermediate state in which an arc occurs is shorter than in a conventional case.

The switching device according to one aspect of the present invention can make it possible that a slide of a sliding member does not depend on a switching operation through a simple configuration thereof.

Moreover, in the switching device according to one aspect of the present invention, (1) the predetermined shaft is located closer to the predetermined contact position than the predetermined fulcrum whereby the sliding member may rotate so that the deformation of the elastic member is maximum in the position being deviated to the side of the predetermined contact position compared to the straight line.

According to the above-mentioned configuration, the switching device of one aspect of the present invention is simply configured so that the horizontal position of the above-mentioned predetermined shaft is deviated to the side of the above-mentioned predetermined contact position compared to the above-mentioned predetermined fulcrum (the above-mentioned predetermined shaft is closer to the above-mentioned predetermined contact position than the above-mentioned predetermined fulcrum), and thereby the above-mentioned deformation of the elastic member can be maximum in the position being deviated to the side of the above-mentioned predetermined contact position compared to the straight line. Namely, the switching device according to one aspect of the present invention can make it possible that a slide of a sliding member does not depend on a switching operation through a simple configuration thereof.

Additionally, in the switching device according to one aspect of the present invention, (1) a projection is provided on the movable member, whereby the sliding member may rotate so that the deformation of the elastic member is maximum in the position being deviated to the side of the predetermined contact position compared to the straight line.

According to the above-mentioned configuration, the switching device of one aspect of the present invention is simply configured so that a projection is provided on the above-mentioned movable member, and thereby the above-mentioned deformation of the elastic member can be maximum in the position being deviated to the side of the above-mentioned predetermined contact position compared to the above-mentioned straight line. Namely, the switching device according to one aspect of the present invention can make it possible that a slide of a sliding member does not depend on a switching operation through a simple configuration thereof.

Additionally, in the switching device according to one aspect of the present invention, (1) the movable member includes a curved portion which is formed in a predetermined end portion of the movable member, and (2) in the sliding member, the predetermined part may slide on the predetermined surface from the side of the predetermined contact position to the curved portion.

In the conventional switch, the movable member thereof only includes a board shape, and therefore, the sliding speed of the sliding member is not made faster or slower in accordance with the shape of the movable member. Namely, the operation speed of the switch and the sliding speed of the sliding member (the speed of a movable contact separating from the fixed contact, in other word) coincide with each other. Therefore, the sliding of the sliding member depends on a switching operation of the switch.

On the other hand, in the switching device according to one aspect of the present invention, since the above-mentioned movable member includes the above-mentioned curved portion, the above-mentioned predetermined part which has slid on the above-mentioned movable member from the side of a predetermined contact position slides at once toward the lowest portion of the above-mentioned curved portion. Namely, the above-mentioned sliding member slides at high speed without depending on the operation speed of the above-mentioned switching device. Thereby, the above-mentioned movable member energetically swings in a hopping manner, and therefore, the above-mentioned movable contact is separated from a fixed contact at high speed. In other words, in the above-mentioned switching device, when the separation of the both contacts of which timing is delayed starts, the above-mentioned movable contact is separated from the above-stated fixed contact at higher speed than in a conventional case so that the both contacts are completely opened immediately. Thereby, the time of the above-mentioned intermediate state in which an arc occurs is shorter than in a conventional case.

Furthermore, conventionally, it is needed to make the casing larger than a predetermined size, and thereby take an internal space thereof widely to some extent in order to prevent the inner wall of the casing from deteriorating due to an arc. On the other hand, the above-mentioned switching device can suppress energy of occurring arcs to be small by separating the both contacts at high speed, and therefore, the internal space thereof does not need to be wide. Therefore, the switching device according to one aspect of the present invention can be smaller than a conventional one.

According to the switching device of one aspect of the present invention, the sliding member rotates so that the deformation of the elastic member is maximum in the position of the predetermined part on the predetermined surface, the position being deviated to the side of the predetermined contact position compared to the straight line which connects the predetermined shaft and the predetermined fulcrum.

Thereby, the above-mentioned switching device can make it possible that a slide of a sliding member does not depend on a switching operation through a simple configuration thereof.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A switching device comprising:
a movable member configured to swing around a predetermined fulcrum;
a movable contact provided on the movable member;
a sliding member of which a predetermined part slides on a predetermined surface of the movable member by a movement of rotating around a predetermined shaft;
an elastic member configured to support the sliding member so as to be slidable while the predetermined part remains abutted on the predetermined surface; and
a fixed contact configured to be contacted with the movable contact in a predetermined contact position,
wherein the movable member swings by a sliding of the sliding member, thereby switching a contact and a noncontact of the movable contact and the fixed contact so as to switch a conduction and a break of an electricity, and
wherein the sliding member is configured to rotate so that a deformation of the elastic member is maximum in a position of the predetermined part on the predetermined surface, the position being deviated to a side of the predetermined contact position compared to a straight line which connects the predetermined shaft and the predetermined fulcrum.

2. The switching device according to claim 1, wherein the sliding member is configured to rotate so that the deformation of the elastic member is maximum in the position being deviated to the side of the predetermined contact position compared to the straight line by positioning the predetermined shaft closer to the predetermined contact position than the predetermined fulcrum.

3. The switching device according to claim 1, wherein the sliding member is configured to rotate so that the deformation of the elastic member is maximum in the position being deviated to the side of the predetermined contact position compared to the straight line by providing a projection to the movable member.

4. The switching device according to claim 1, wherein the movable member comprises a curved portion which is formed on a predetermined end portion of the movable member, the predetermined part of the sliding member being configured to slide on the predetermined surface from the side of the predetermined contact position to the curved portion.

5. The switching device according to claim 2, wherein the sliding member is configured to rotate so that the deformation of the elastic member is maximum in the position being deviated to the side of the predetermined contact position compared to the straight line by providing a projection to the movable member.

6. The switching device according to claim 2, wherein the movable member comprises a curved portion which is formed on a predetermined end portion of the movable member, the predetermined part of the sliding member being configured to slide on the predetermined surface from the side of the predetermined contact position to the curved portion.

7. The switching device according to claim 3, wherein the movable member comprises a curved portion which is formed on a predetermined end portion of the movable member, the predetermined part of the sliding member being configured to slide on the predetermined surface from the side of the predetermined contact position to the curved portion.

8. The switching device according to claim 5, wherein the movable member comprises a curved portion which is formed on a predetermined end portion of the movable member, the predetermined part of the sliding member being configured to slide on the predetermined surface from the side of the predetermined contact position to the curved portion.
